(19) United States
(12) Patent Application Publication
(10) Pub. No.: US 2006/0165888 A1
(43) Pub. Date: Jul. 27, 2006

(54) Method of forming linear patterns

(76) Inventors: Jungwei John Cheng, Min-Hsiung (TW); Jeng-Rong Ho, Min-Hsiung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/252,554

(22) Filed: Oct. 19, 2005

(30) Foreign Application Priority Data
Jan. 21, 2005 (TW) 094101836

(51) Int. Cl. B05D 3/12

(52) U.S. Cl. 427/240

(57) ABSTRACT

The present invention discloses a method of forming linear patterns, called “directional spin coating” technology. Parallel banks are formed on a substrate to define some trenches; the substrate is vertically erected on outer edge of a spin disc; and a liquid material is applied to the trenches, the spin disc is rotated, and with the centrifugal force of rotation, the material is uniformly coated on the substrate within individual trenches to form a linear pattern. The thickness of the formed pattern is similar to that achievable using the conventional spin-coating approach. The present invention can create linear patterns made of more than one material by selectively coating different materials on specific trenches.

### BACKGROUND OF INVENTION

1. Field of the Invention

The invention relates to a method of coating linear patterns that can be applied to the micro and nano fabrication, and more particularly, can be applied to the linear patterns made of different materials. The claimed invention is called “directional spin coating” technology.

2. Description of the Prior Art

In the micro and nano fabrication, one essential procedure is forming patterns with a specific shape and thickness on the substrate. Nowadays, a practical method is growing a thin film layer and then writing patterns on it.

Typical thin film growing methods include various approaches of chemical vapor deposition (CVD) and physical vapor deposition (PVD) and the spin coating method while pattern writing is achieved by different wet or dry etching methods. Generally speaking, among the conventional methods, film growing using spin coating followed by pattern writing through etching constitutes the most economic and commonly utilized approach. With this conventional method, a liquid material is placed on the substrate, and then the substrate is rotated at high speed and the material is uniformly coated on the substrate under the effect of the centrifugal force. After that, an etching process is performed to write patterns on the film. However, the spin-coating plus etching approach is intrinsically limited to creation of patterns made of a single material, and suffers a disadvantage that when wet etching is adopted, it becomes unsuitable for applications involving materials intolerant to solvent exposure after spin-coating. As a result, when fabricating patterns consisting of different materials, the spin-coating approach should be coordinated with more elaborate and expensive etching process such as ion-beam etching, or be replaced by the mask-defined PVD and CVD approaches that have higher manufacture cost. Hence, the present invention discloses the “directional spin coating” technology that achieves the objective of forming linear patterns with different materials while maintaining the inherent advantages of convenience and low cost of the spin coating method.

### SUMMARY OF INVENTION

It is therefore a primary objective of the claimed invention to provide a method of coating linear patterns that can selectively coat different materials on specific areas, and the thickness of the patterns is similar to that achievable using the conventional spin-coating approach. Furthermore, the present invention also has the advantage of low manufacture cost, and the cost will not be raised while fabricating patterns with different materials.

According to an embodiment of the claimed invention, at least two parallel banks are formed on a substrate to define at least one trench; the substrate is vertically erected on outer edge of a spin disc; and at least one material are placed at one end of the trench and the spin disc is rotated, with the centrifugal force of rotation, giving rise to uniformly coating the material on the substrate within the trench to form a linear pattern.

According to another embodiment of the claimed invention, a plurality of parallel banks are formed on the substrate to define a plurality of trenches; the substrate is vertically erected on outer edge of the spin disc; and at least two materials are separately placed at one end of different trenches and the spin disc is rotated, with the centrifugal force of rotation, giving rise to separately and uniformly coating the different materials on the substrate within the different trenches to form the linear pattern with different materials.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a substrate having a linear pattern.

FIG. 2a is a structural diagram of the banks grown on the substrate according to the present invention.

FIG. 2b is a structural diagram of the banks etched and fabricated on the substrate according to the present invention.

FIG. 3a is a structural diagram of performing the directional spin coating according to the present invention.

FIG. 3b is another structural diagram of performing the directional spin coating according to the present invention.

### DETAILED DESCRIPTION

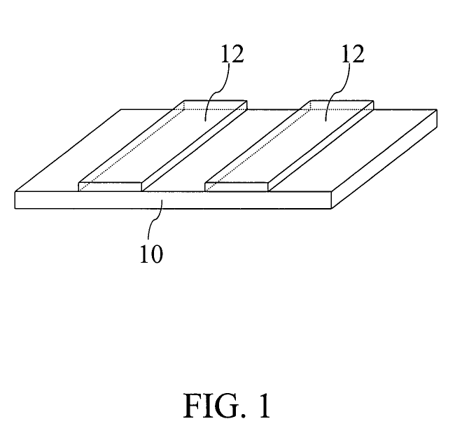

The present invention discloses a method to accomplish linear patterns made of either same or different materials, and the thickness of the patterns is similar to that achievable using the conventional spin-coating approach. In addition, the claimed method can further overcome the limitation and disadvantages of the conventional spin-coating plus etching approach. The present invention can be divided into two sequential sub-precesses, forming banks for isolation and spin-coating the linear patterns. FIG. 1 shows a schematic diagram of a substrate with a linear pattern. As shown, the linear pattern 12 is formed on the substrate 10. The linear pattern 12 can be of either same or different materials. The process of forming the linear pattern 12 is described hereinafter.

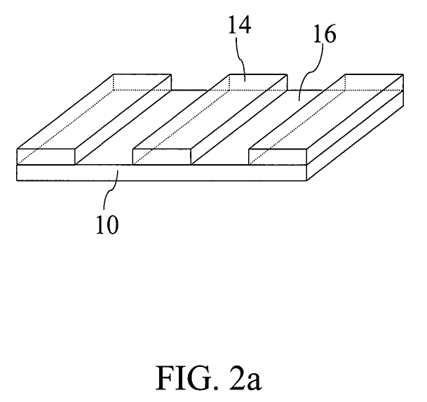

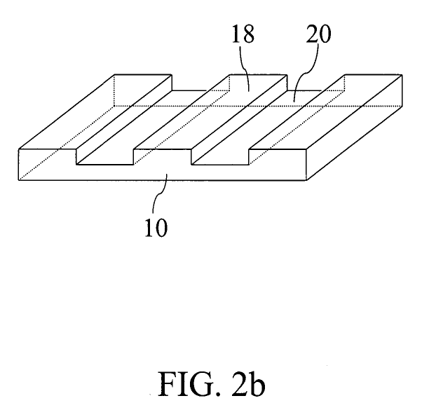

Firstly, the banks for isolation are formed. FIG. 2a is the structural diagram of the banks grown on the substrate according to the present invention. Many existing semiconductor processes can be utilized to form the banks. For example, a plurality of parallel banks 14 defining a plurality of trenches 16 on a substrate 10 can be created by acquiring a substrate 10, growing a film (not shown) on the substrate, and then applying the photolithography process to remove unnecessary film. Alternatively, as shown in FIG. 2b, the banks can be directly formed within the substrate. Both dry and wet etching technologies can be utilized to etch the substrate 10 to form a plurality of separating banks 18 in the substrate, defining a plurality of trenches 20. Existent etching processes such as high energy e-beam can be utilized to directly etch the substrate 10 to fabricate the banks 18.

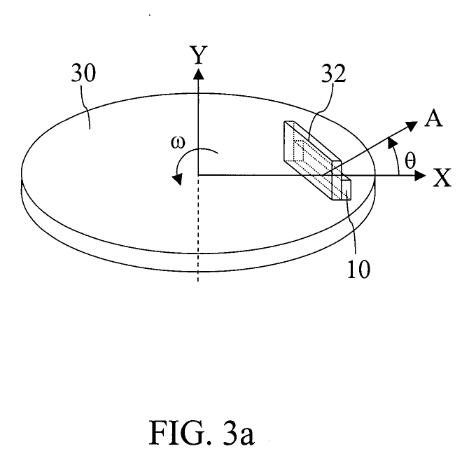

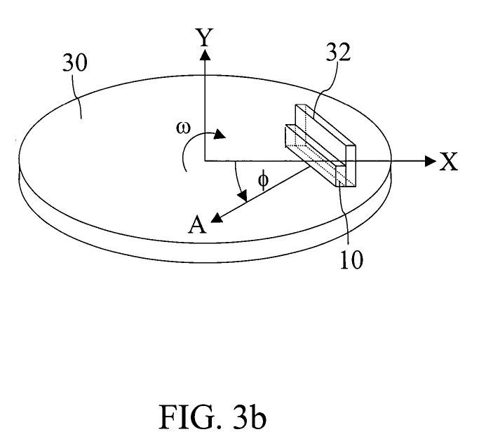

Then, the process of spin coating linear patterns is performed. FIG. 3a and FIG. 3b are structural diagrams of performing the directional spin coating according to the present invention. A spin disc 30 is provided and a substrate holder 32 is fixed on it. The substrate 10 having the banks 14 or 18 shown in FIG. 2a or FIG. 2b (the banks are omitted in FIG. 3a and FIG. 3b) is then placed on the substrate holder 32. The normal vector A of the substrate 10 is orthogonal to the normal vector Y of the spin disc 30, and forms an angle θ with the radial vector X of the spin disc 30. The angular velocity vector of the spin disc 30 is ω. The angular velocity ω is positive if the spin disc 30 rotates counterclockwise with respect to the normal vector Y using the right hand rule. The angle θ is defined as the angle from the radial vector X of the spin disc 30 and the normal vector A of the substrate 10, and its sign is defined using the right hand rule from the radial vector X to the normal vector A with a counterclockwise swing indicating a positive angle θ. When the pointing of the normal vector A is the same as what shown in FIG. 3a, i.e., the side of the substrate 10 having banks facing outward, the angle θ and the angular velocity vector ω should be of the same sign. Specifically, when the angle θ is positive, the rotation direction of the spin disc 30 should be counterclockwise as shown in FIG. 3a, or when the angle θ is negative, the rotation direction of the spin disc 30 should be clockwise. Hence, when the normal vector A of the substrate 10 points outward (the direction radiating from center of the spin disc to periphery is defined outward), the angle θ is adjustable between −90 to +90 degrees.

FIG. 3b shows another installation for spin-coating linear patterns, wherein the substrate 10 is placed on the inner side of the substrate holder 32. In this case, an angle φ is defined as the angle from the negative of the radial vector X of the spin disc 30 to the normal vector A of the substrate 10, and its sign is defined using the right hand rule from the negative of the radial vector X to the normal vector A. In this installation, the signs of the angle φ and the angular velocity vector ω should be opposite. Specifically, when the angle φ is positive, the rotation direction of the spin disc 30 should be clockwise as shown in FIG. 3b, or when the angle φ is negative, the rotation direction of the spin disc 30 should be counterclockwise. Hence, when the normal vector A of the substrate 10 points inward, the angle φ is adjustable between −90 to +90 degrees.

The liquid coating material is placed at one end of the trench 16 or 20 defined by the banks 14 or 18 shown in FIG. 2a or FIG. 2b with a suitable liquid dispenser (not shown). When the spin disc 30 rotates with the substrate 10, with the centrifugal force of rotation, the material in the trench 16 or 20 on the substrate 10 is linearly coated on the substrate 10 within the trench 16 or 20 to form a linear pattern with a uniform thickness. After removing the banks, the linear pattern 12 shown in FIG. 1 can be obtained. Wherein, thickness of the linear pattern 12 can be controlled by adjusting rotational speed ω of the spin disc 30 and the angle θ or φ between the radial vector X of the spin disc 30 and the normal vector A of the substrate 10.

Furthermore, if different specific areas of the linear pattern 12 of FIG. 1 are requested to be coated with different materials, at least two materials are separately placed on different trenches on the substrate. With the centrifugal force of rotation, the different materials are separately and uniformly coated on the substrate within the different trenches to form the linear pattern with different materials. Of course, the materials can be placed on the trenches simultaneously and rotated synchronously, or each material can be placed and rotated sequentially, one after another.

In addition, no matter the directional spin coating is performed with either same or different materials, the linear pattern 12 of FIG. 1 can be accomplished in a single coating procedure or the trenches of the linear pattern can be coated individually or area by area by repeatedly employing the coating procedure described above.

In contrast to the prior art, the present invention can selectively coat different materials on specific areas to form linear patterns, and the thickness of the patterns is similar to that achievable using the conventional spin-coating approach. Furthermore, the present invention also enjoys the advantage of low manufacture cost, and the cost will not be raised when fabricating patterns with different materials. Hence, the present invention can be extensively applied, but not limited, to semiconductor process and the fabrication of Micro and Nano Electro-Mechanical Systems (MEMS/NEMS) devices.

Those skilled in the art will readily observe that numerous modifications and alterations to the foregoing description and illustration of the present invention may be made while retaining the teachings of the invention. Accordingly, the above disclosure should be construed as limited only by the metes and bounds of the appended claims.

What is claimed is:

1. A method of forming linear patterns, comprising:
forming at least two parallel banks on a substrate to define at least one trench;
vertically erecting the substrate on outer edge of a spin disc; and
placing at least one liquid material at one end of the trench or trenches and rotating the spin disc, with the centrifugal force of rotation, giving rise to uniformly coating the material or materials on the substrate within the trench or trenches to form a linear pattern.

2. The method of forming linear patterns of claim 1, wherein, when the linear pattern on the substrate is formed by different materials, the method comprising:
forming a plurality of parallel banks on the substrate to define a plurality of trenches;
vertically erecting the substrate on outer edge of the spin disc; and
separately placing at least two materials at one end of different trenches and rotating the spin disc, with the centrifugal force of rotation, giving rise to separately and uniformly coating the different materials on the substrate within the different trenches to form the linear pattern with different materials.

3. The method of forming linear patterns of claim 1, wherein the normal vector of the substrate is orthogonal to the normal vector of the spin disc, and an angle is defined from the radial vector of the spin disc to the normal vector of the substrate.

4. The method of forming linear patterns of claim 3, wherein, when the normal vector of the substrate points outward, the angle is adjustable between 0 to +90 degrees or 0 to −90 degrees, and when the angle is 0 to +90 degrees, the spin disc is rotated counterclockwise, and when the angle is 0 to −90 degrees, the spin disc is rotated clockwise.

5. The method of forming linear patterns of claim 3, wherein, when the normal vector of the substrate points inward, the angle is adjustable between +180 to +270 degrees or −180 to −270 degrees, and when the angle is +180 to +270 degrees, the spin disc is rotated clockwise, and when the angle is −180 to −270 degrees, the spin disc is rotated counterclockwise.

6. The method of forming linear patterns of claim 3, wherein thickness of the linear pattern can be controlled by adjusting rotational speed of the spin disc and the angle defined by the radial vector of the spin disc and the normal vector of the substrate.

7. The method of forming linear patterns of claim 2, wherein the normal vector of the substrate is orthogonal to the normal vector of the spin disc, and an angle is defined from the radial vector of the spin disc to the normal vector of the substrate.

8. The method of forming linear patterns of claim 7, wherein, when the normal vector of the substrate points outward, the angle is adjustable between 0 to +90 degrees or 0 to −90 degrees, and when the angle is 0 to +90 degrees, the spin disc is rotated counterclockwise, and when the angle is 0 to −90 degrees, the spin disc is rotated clockwise.

9. The method of forming linear patterns of claim 7, wherein, when the normal vector of the substrate points inward, the angle is adjustable between +180 to +270 degrees or −180 to −270 degrees, and when the angle is +180 to +270 degrees, the spin disc is rotated clockwise, and when the angle is −180 to −270 degrees, the spin disc is rotated counterclockwise.

10. The method of forming linear patterns of claim 7, wherein thickness of the linear pattern can be controlled by adjusting rotational speed of the spin disc and the angle defined by the radial vector of the spin disc and the normal vector of the substrate.

11. The method of forming linear patterns of claim 1, wherein the forming method of the banks can be accomplished by employing any suitable additive approach onto the substrate, or performing any carving method directly to the substrate.

12. The method of forming linear patterns of claim 2, wherein the forming method of the banks can be accomplished by employing any suitable additive approach onto the substrate, or performing any carving method directly to the substrate.

13. The method of forming linear patterns of claim 1, wherein the linear pattern of same material can be made in a single coating procedure or the trenches can be coated individually or area by area by repeatedly employing the coating procedure.

14. The method of forming linear patterns of claim 2, wherein different materials are classified into groups.

15. The method of forming linear patterns of claim 14, wherein the different materials of each group can be coated on the substrate within the different trenches by repeatedly employing the coating procedure, or these different materials can be placed at one end of the different trenches simultaneously and rotated synchronously to coat within the different trenches on the substrate.

16. The method of forming linear patterns of claim 14, wherein the different materials can be repeatedly coated on the substrate within the different trenches group by group to form a linear pattern with different materials, or different materials can be placed at one end of the different trenches simultaneously and rotated synchronously to form a linear pattern with different materials.
